(19) United States
(12) Patent Application Publication
(10) Pub. No.: US 2008/0215539 A1
(43) Pub. Date: Sep. 4, 2008

(54) DATA ORDERING FOR DERIVED COLUMNS IN A DATABASE SYSTEM

(75) Inventors: Eric Lawrence Barsness, Pine Island, MN (US); John Matthew Santosuosso, Rochester, MN (US)

Correspondence Address: MARTIN & ASSOCIATES, LLC, P.O. BOX 548, CARTHAGE, MO, 64836-0548, US

(73) Assignee: International Business Machines Corporation, Armonk, NY (US)

(21) Appl. No.: 12/119,963

(22) Filed: May 13, 2008

Related U.S. Application Data
(63) Continuation of application No. 10/970,523, filed on Oct. 21, 2004.

(51) Int. Cl. G06F 7/06

(52) U.S. Cl. 707/2; 707/E17.017

(57) ABSTRACT

Optimized query execution is disclosed for queries that return data sorted by a derived column. The query optimizer is used to determine if the data is already sorted or if existing database metadata can be utilized to provide the sort. The optimizer will examine the query field being derived and attempt to determine if there are existing index structures that can be used to sort the data. The optimizer can also look at the values of the data in the column to determine what existing structures can be used to sort the data.

### CROSS-REFERENCE TO RELATED APPLICATION

This patent application is a continuation of U.S. Ser. No. 10/970,523 filed on Oct. 21, 2004, which is incorporated herein by reference.

### BACKGROUND OF THE INVENTION

1. Technical Field

This invention generally relates to computer systems, and more specifically relates to access in a computer database system.

2. Background Art

Database systems have been developed that allow a computer to store a large amount of information in a way that allows a user to search for and retrieve specific information in the database. For example, an insurance company may have a database that includes all of its policy holders and their current account information, including payment history, premium amount, policy number, policy type, exclusions to coverage, etc. A database system allows the insurance company to retrieve the account information for a single policy holder among the thousands and perhaps millions of policy holders in its database.

Retrieval of information from a database is typically done using queries. A query usually specifies conditions that apply to one or more columns of the database, and may specify relatively complex logical operations on multiple columns. The database is searched for records that satisfy the query, and those records are returned as the query result.

Many applications require data returned from a database query to be in a certain order. It is usually much faster for the database system to sort the data and return it to the application already sorted rather than have the application sort the data. Sometimes it is a simple matter for the database to sort the data because there is often an index in the database that can be used to gather the data quickly in the proper order provided by the index.

When data needs to be sorted by a derived column it is not as simple to return data from the database in a specific order. A derived column is a column in the result set that does not directly map to a column in a table. The derived column is usually based off a pre-defined column and a computation is done to generate the derived column. Or the derived column is generated by performing a function between two or more columns. In the prior art database systems, when data needed to be sorted by a derived column, the database would retrieve the information and copy it into a temporary data space and then sort the data in the temporary data space. Copying and sorting the data in the temporary space requires additional, costly system resources. The additional costs can be significant in large database systems. Without a way to reduce database sorting of derived columns to improve system performance, the computer industry will continue to suffer from excessive costs in database system resources due to sorting data for derived columns.

### DISCLOSURE OF INVENTION

The present invention provides improved database performance by optimizing query execution for queries that return data sorted by a derived column. The query optimizer is used to determine if the data is already sorted or if existing database metadata can be utilized to provide the sort. The optimizer will examine the query field being derived and attempt to determine if there are existing index structures that can be used to sort the data. The optimizer can also look at the values of the data in the column to determine whether existing index structures can be used to sort the data.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a block diagram of an apparatus in accordance with the preferred embodiments;

FIG. 2 shows a sample database query in Structured Query Language (SQL) for the database table shown in FIG. 3;

FIG. 3 shows a sample database table;

FIG. 4 shows another sample database table;

FIG. 5 shows a sample database query in Structured Query Language (SQL) for the database table shown in FIG. 4;

FIG. 6 shows a sample data output for the database query shown in FIG. 5;

FIG. 7 shows another sample database query in Structured Query Language (SQL) for the database table shown in FIG. 4;

FIG. 8 shows a sample database query in Structured Query Language (SQL) for the database table shown in FIG. 4;

FIG. 9 shows a sample data output for the database query shown in FIG. 8; and

FIG. 10 shows a general method in accordance with the preferred embodiments for optimizing data ordering for a derived column in a database.

### BEST MODE FOR CARRYING OUT THE INVENTION

1.0 Overview

The present invention relates to optimizing database queries. For those not familiar with databases or queries, this Overview section will provide background information that will help to understand the present invention.

Known Databases and Database Queries

There are many different types of databases known in the art. The most common is known as a relational database (RDB), which organizes data in tables that have rows that represent individual entries or records in the database, and columns that define what is stored in each entry or record.

To be useful, the data stored in databases must be able to be efficiently retrieved. The most common way to retrieve data from a database is to generate a database query. A database query is an expression that is evaluated by a database manager. The expression may contain one or more predicate expressions that are used to retrieve data from a database. For example, let's assume there is a database for a company that includes a table of employees, with columns in the table that represent the employee's name, address, phone number, gender, and salary. With data stored in this format, a query could be formulated that would retrieve the records for all female employees that have a salary greater than $40,000. Similarly, a query could be formulated that would retrieve the records for all employees that have a particular area code or telephone prefix.

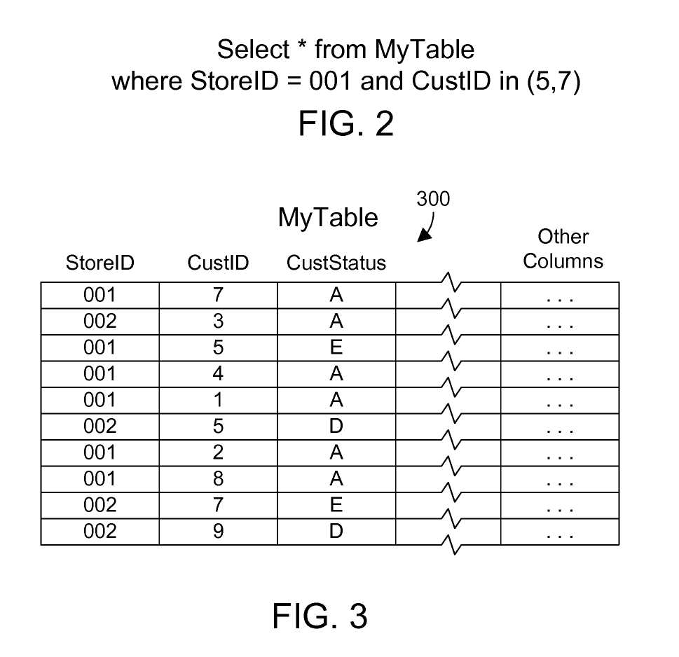

One popular way to define a query uses Structured Query Language (SQL). SQL defines a syntax for generating and processing queries that is independent of the actual structure and format of the database. One sample SQL query is shown in FIG. 2.

The “SELECT*” statement tells the database query processor to select all values, the “from MyTable” statement identifies which database table to search, and the “where” clause specifies one or more expressions that must be satisfied for a record to be included in the resulting dataset. Note that the query of FIG. 2 is expressed in terms of columns StoreID and CustID, which are columns defined on the database table MyTable 300 shown in FIG. 3. MyTable 300 is a suitable table that the query of FIG. 2 could be run against. MyTable 300 includes multiple rows and multiple columns. Information about the internal storage of the data is not required as long as the query is written in terms of expressions that relate to values in columns from tables.

2.0 Description of the Preferred Embodiments

The present invention provides improved database performance by optimizing query execution for queries that return data sorted by a derived column. The query optimizer is used to determine if the data is already sorted or if existing database metadata can be utilized to provide the sort. The database query optimizer is part of a database manager executing on a computer database system. A computer system suitable for executing the query optimizer according to preferred embodiments is first described.

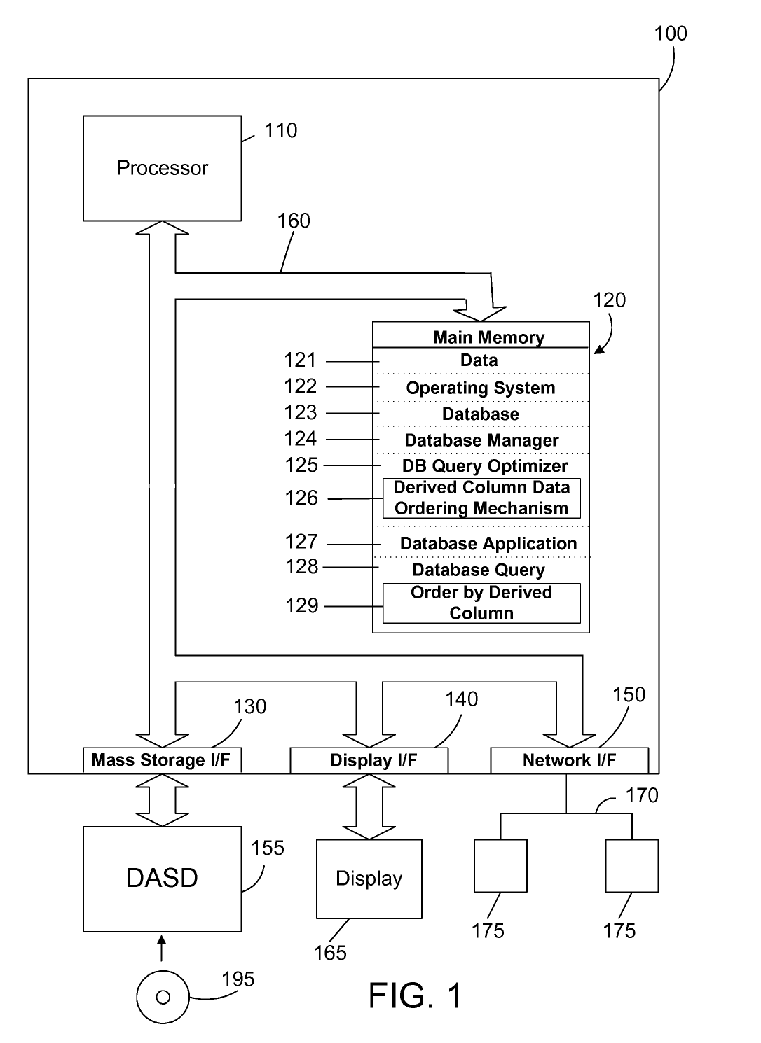

Referring to FIG. 1, a computer system 100 is one suitable implementation of an apparatus in accordance with the preferred embodiments of the invention. Computer system 100 is an IBM eServer iSeries computer system. However, those skilled in the art will appreciate that the mechanisms and apparatus of the present invention apply equally to any computer system, regardless of whether the computer system is a complicated multi-user computing apparatus, a single user workstation, or an embedded control system. As shown in FIG. 1, computer system 100 comprises a processor 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD RW drive, which may store data to and read data from a CD RW 195.

Main memory 120 in accordance with the preferred embodiments contains data 121, an operating system 122, a database 123, a database manager 124, a database query optimizer 125, a database application 127, and one or more database queries 128 including a database query ordered by a derived column 129. Data 121 represents any data that serves as input to or output from any program in computer system 100. Operating system 122 is a multitasking operating system known in the industry as OS/400; however, those skilled in the art will appreciate that the spirit and scope of the present invention is not limited to any one operating system. Database 123 is any suitable database, whether currently known or developed in the future. Database 123 preferably includes one or more tables. Database manager 124 provides an interface to database 123, processing queries and returning the query results. Database application 127 is software program executing on processor 100 and having a database query 128. Database query 128 is a query in a format compatible with the database 123 that allows retrieval of information stored in the database 123 that satisfies the database query 128. The database query optimizer 125 having a derived column data ordering mechanism 126 and a database query 128 having an ORDER BY clause with a derived column 129 is described further below.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, database 123, database manager 124, query optimizer 125, derived column data ordering mechanism 126, database application 127, database query 128, are shown to reside in main memory 120, those skilled in the art will recognize that these items are not necessarily all completely contained in main memory 120 at the same time. It should also be noted that the term “memory” is used herein to generically refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Operating system 122 is a sophisticated program that manages the resources of computer system 100. Some of these resources are processor 110, main memory 120, mass storage interface 130, display interface 140, network interface 150, and system bus 160.

Although computer system 100 is shown to contain only a single processor and a single system bus, those skilled in the art will appreciate that the present invention may be practiced using a computer system that has multiple processors and/or multiple buses. In addition, the interfaces that are used in the preferred embodiment each include separate, fully programmed microprocessors that are used to off-load compute-intensive processing from processor 110. However, those skilled in the art will appreciate that the present invention applies equally to computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. The present invention applies equally no matter how computer system 100 may be connected to other computer systems and/or workstations, regardless of whether the network connection 170 is made using present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol. The database described above may be distributed across the network, and may not reside in the same place as the application software accessing the database. In a preferred embodiment, the database primarily resides in a host computer and is accessed by remote computers on the network which are running an application with an internet type browser interface over the network to access the database.

At this point, it is important to note that while the present invention has been and will continue to be described in the context of a fully functional computer system, those skilled in the art will appreciate that the present invention is capable of being distributed as a program product in a variety of forms, and that the present invention applies equally regardless of the particular type of computer-readable signal bearing media used to actually carry out the distribution. Examples of suitable computer-readable signal bearing media include: recordable type media such as floppy disks and CD RW (e.g., 195 of FIG. 1), and transmission type media such as digital and analog communications links.

Again referring to FIG. 1, computer system 100 is shown with a query optimizer 125 in memory 120 in accordance with preferred embodiments. The query optimizer 125 provides improved database performance by optimizing query execution by the database manager 123 for queries 128 that return data ordered by a derived column 129. The query optimizer 125 has a derived column data ordering mechanism 126 that performs the novel features described herein for the query optimizer 125. The query optimizer 125 is used to examine the field being derived and determine if the data is already sorted or if existing database metadata can be utilized to provide the sort. The query optimizer 125 also looks at the values of the data in the column to see if existing database metadata can be utilized to provide the sort.

Embodiments are described herein for using the query optimizer 125 to order query results using existing database metadata. We assume as an example that database query 128 is an SQL query, and that ordering by a derived column 129 is accomplished via an ORDER BY clause in the SQL query. To determine if the query can be optimized, the query optimizer 125 checks for at least the following categories of ORDER BY clauses that can be optimized, including: 1) the ORDER BY clause is a known function derivative, 2) the derived column is a deterministic function on a preset column, 3) the contents of the column determines the derived columns order, and 4) storing a derived column in a separate indexable structure for a derived column that is used often to create the existing metadata. The following illustrations and description of embodiments provide examples where the query optimizer 125 is utilized to determine if existing database metadata can be to used to execute the sort specified by the ORDER BY clause.

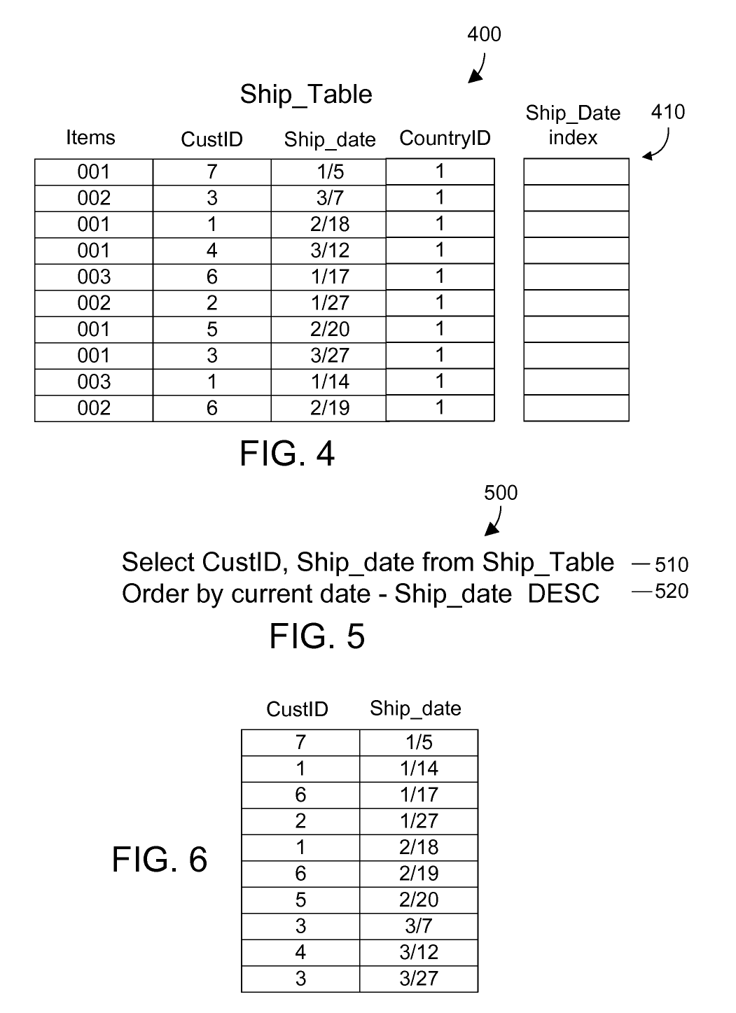

FIG. 4 shows a sample database table 400 to illustrate the operation of the query optimizer 125 (FIG. 1) in accordance with preferred embodiments. The table's name is “Ship_Table.” The sample table 400 includes 10 rows of data for each column. The column names are “Items,” “CustID,” “Ship_date,” and “CountryID.” FIG. 4 also shows an index 410 for the “Ship_date” column (the contents of the index are not shown).

FIG. 5 shows a sample database query 500 in Structured Query Language (SQL) for the database table shown in FIG. 4. Query 500 includes a SELECT statement 510 and an ORDER BY statement 520. The SELECT statement 510 selects two columns (CustID, Ship_date) from the table (Ship_Table). The ORDER BY clause 520 instructs the database manager 124 to order the results of the SELECT statement 510 by current date-ship_date in descending order. The query optimizer will examine the derived column in the query and determine the derived column is a known function derivative on a column with an existing database index structure, namely Ship_date index 410. In this case “current date” is a built in value in the database system. The function of subtracting the ship date from the current date is therefore a known function and has known result—the older the ship date the larger the answer will be. Since the answer for the function of the derived column will have the same order as the index on the ship date column, the index can be used to sort the data for this query. The query optimizer 125 will then instruct the database manager 124 to use the Ship_date index to order the query results.

FIG. 6 shows the data output for the database query shown in FIG. 5. The output data is a CustID column and a Ship_date column of data from Ship table. The data in the output columns are sorted by the Ship_date, oldest to most recent. In contrast to the prior art, the data in FIG. 6 was not sorted using a temporary table of the derived data.

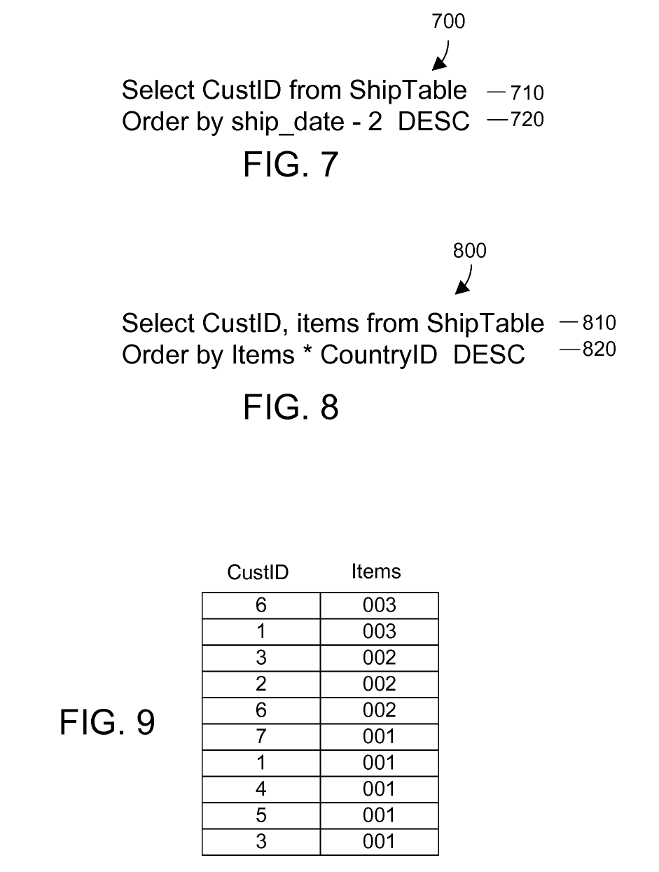

FIG. 7 shows another sample database query 700 in SQL for the database table shown in FIG. 4. Query 700 includes a SELECT statement 710 and an ORDER BY statement 720. The SELECT statement 710 selects two columns (CustID, Ship_date) from the table (Ship_Table). The ORDER BY clause 720 instructs the database manager 124 to order the output by ship_date-2 in descending order. The query optimizer will examine the derived column in the query and determine the derived column is a deterministic function call on a preset column, and that the preset column has an existing database structure (Ship_date index 410). The query optimizer 125 will then instruct the database manager 124 to use the Ship_date index to order the query results. FIG. 6 also shows the data output for the database query shown in FIG. 7. The output data is a CustID column and a Ship_date column of data from Ship table. The data in the output columns are sorted by the Ship_date using the Ship_date index 410. In contrast to the prior art, the data in FIG. 6 was not sorted using a temporary table of the derived data.

FIG. 8 shows another sample database query 800 in SQL for the database table shown in FIG. 4. Query 800 includes a SELECT statement 810 and an ORDER BY statement 820. The SELECT statement 820 also selects two columns (CustID, Items) from the table (Ship_Table). The ORDER BY clause 810 instructs the database manager 124 to order the output by Items*CountryID in descending order. The query optimizer will examine the columns in the query and determine the field contents of the derived column has a known order with an existing database index structure (Ship_date index 410). In this case “CountryID” is a constant value. The function of multiplying a column by a constant results in a column with the same order. Since the answer for the function of the derived column will have the same order as the index on the ship date column, the index can be used to sort the data for this query. The query optimizer 125 will then instruct the database manager 124 to use the Ship_date index 410 to order the query results.

FIG. 9 shows the data output for the database query shown in FIG. 8. The output data is a CustID column and an Items column of data from Ship table. The data in the output columns are sorted by the Items column. In contrast to the prior art, the data was not sorted using a temporary table of the derived data.

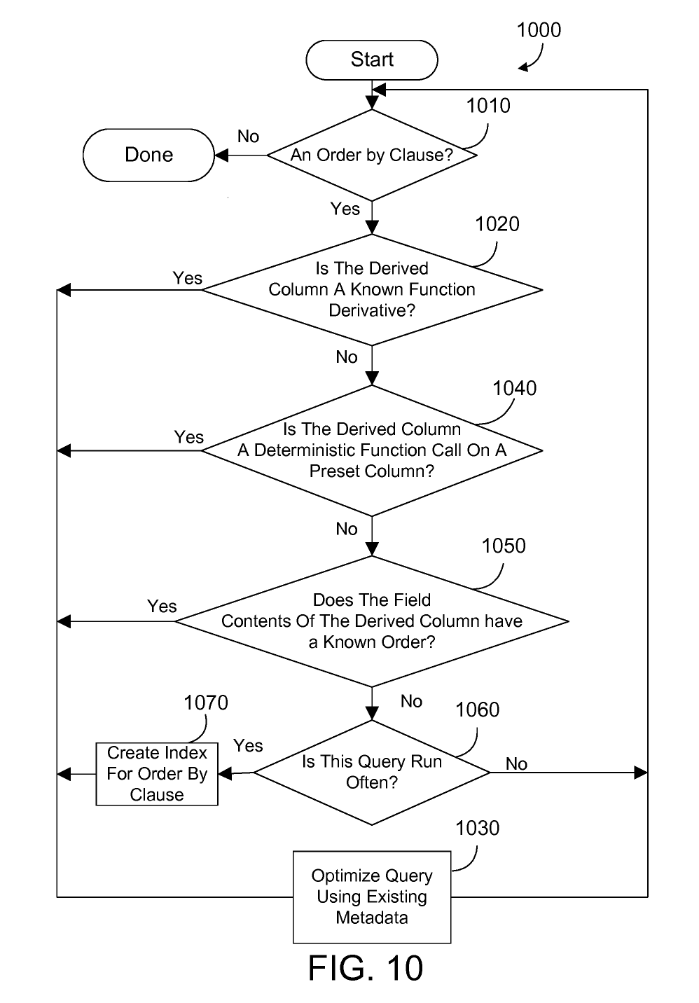

A method 1000 in FIG. 10 shows the steps of a query optimizer to optimize database access according to an embodiment of the present invention. The query optimizer first determines if there is a query with an ORDER BY clause (step 1010). If there are no queries with ORDER BY clauses (step 1010=no) then the method is done. If there are queries with ORDER BY clauses (step 1010=yes) then the optimizer checks for different ways to optimize the query execution with existing metadata. The optimizer first checks if the derived column is a known function derivative (step 1020), and if so (step 1020=yes) proceeds to step 1030. If the derived column is not a known function derivative (step 1020=no), the optimizer then checks if the derived column is a deterministic call on a known preset column (step 1040), and if so (step 1040=yes) then proceeds to step 1030. If the derived column is not a deterministic call on a known preset column (step 1040=no), the optimizer then checks if the field contents of the derived column have a known order (step 1050), and if so (step 1050=yes) then proceeds to step 1030. If the field contents of the derived column does not have a known order (step 1050=no), the optimizer then checks if the query is run often (step 1060), and if so (step 1060=yes) then creates an index for the ORDER BY clause (step 1070) and then proceeds to step 1030. The operation of step 1030 is to optimize the query execution using existing metadata. The optimization of the query will vary depending on the type of query as discovered in steps 1020, 1040, 1050 and 1060. The details of the optimization for each of these types was described above.

The present invention as described with reference to the preferred embodiments herein provides significant improvements over the prior art. The preferred embodiments provide improved database performance by optimizing query execution for queries that return data sorted by a derived column. The increased database performance by optimizing query execution will reduce costs associated with large database systems in the computer industry.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

1. A method for optimizing a database query, the method comprising the steps of:
identifying the query contains an ORDER BY clause with a derived column;
identifying if execution of the query can be optimized using existing metadata that has the same order as the derived column; and
instructing the database manager to optimize execution of the database query using existing metadata to order results of the query.

2. The method of claim 1 wherein the database manager optimizes the execution of the ORDER BY clause using an index for a column of the ORDER BY clause.

3. The method of claim 1 wherein the query optimizer recognizes repeated use of a derived column in the ORDER BY clause and generates an index for a derived column in the ORDER BY clause.

4. The method of claim 1 wherein the query optimizer determines whether the derived column in the ORDER BY clause is a known function derivative, and an answer for the function derivative has the same order as the existing metadata.

5. The method of claim 1 wherein the query optimizer determines whether the derived column in the ORDER BY clause is a deterministic function on a preset column, and the preset column can be used as the existing metadata that has the same order as the derived column.

6. The method of claim 1 wherein the query optimizer determines whether the contents of the derived column in the ORDER BY clause has a known order that can be used as the existing metadata that has the same order as the derived column.

7. The method of claim 1 wherein the query optimizer determines whether the derived column in the ORDER BY is used often, and if so, generates and stores metadata for the derived column that indicates the order for the derived column.
